(19) United States
(12) Patent Application Publication
(10) Pub. No.: US 2003/0234749 A1
(43) Pub. Date: Dec. 25, 2003

(54) System and method for communicating graphics image data over a communication network for display on a single logical screen

(76) Inventors: Johnny Marks, Fort Collins, CO (US); Roland M. Hochmuth, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/176,219

(22) Filed: Jun. 20, 2002

(51) Int. Cl. G09G 5/00

(52) U.S. Cl. 345/2.1

(57) ABSTRACT

A system and method for communicating graphics image data over a communication network for display on a single logical screen is disclosed. The method comprises reading graphics image data from a plurality of frame buffers of a graphics adapter, each of the plurality of frame buffers storing graphics image data corresponding to different ones of the plurality of physical display units, and formatting at least a portion of the graphics image data stored in each of the plurality of frame buffers into a plurality of packets for transmission by a network interface of the graphics adapter over the communication network for display on the single logical screen.

### CROSS-REFERENCE TO RELATED APPLICATIONS

This patent application is related to co-pending U.S. patent application, Ser. No. 10/004,191, entitled “SYSTEM AND METHOD FOR DISPLAYING AN IMAGE ON A NETWORK ATTACHABLE DISPLAY DEVICE,” filed Oct. 31, 2001, and incorporated herein by reference; U.S. patent application, Ser. No. 10/001,430, entitled “SYSTEM AND METHOD FOR COMMUNICATING GRAPHICS IMAGE DATA OVER A COMMUNICATION NETWORK,” filed Oct. 31, 2001, and incorporated herein by reference; U.S. patent application, Ser. No. 09/960,523, entitled “SYSTEM AND METHOD FOR COMMUNICATING GRAPHICS OVER A NETWORK,” filed Sep. 21, 2001, and incorporated herein by reference; U.S. Pat. No. 6,084,553, entitled “DESIGN AND METHOD FOR A LARGE, VIRTUAL WORKSPACE, issued Jul. 4, 2000, and incorporated herein by reference; U.S. Pat. No. 6,215,486, entitled “EVENT HANDLING IN A SINGLE LOGICAL SCREEN DISPLAY USING MULTIPLE REMOTE COMPUTER SYSTEMS,” issued Apr. 10, 2001, and incorporated herein by reference; and U.S. Pat. No. 6,249,294, entitled 3D GRAPHICS IN A SINGLE LOGICAL SCREEN DISPLAY USING MULTIPLE COMPUTER SYSTEMS,” issued Jun. 19, 2001, and incorporated herein by reference.

### TECHNICAL FIELD OF THE INVENTION

The present invention relates generally to the field of computer systems, and more particularly to a system and method for communicating graphics image data over a communication network for display on a single logical screen.

### BACKGROUND OF THE INVENTION

In existing computer systems, a user's input intended to modify the image on a display is transmitted as a command with the associated data from a CPU (Central Processing Unit) to a graphics adapter via an AGP (Accelerated Graphics Port) and over a PCI (Peripheral Component Interconnect) bus. A graphics chip on the graphics adapter renders the image based at least in part on the received command. Graphics image data associated with the rendered image is stored in a frame buffer. The image information is typically stored in the frame buffer in a digital format. The digital data stored in the frame buffer controls the color and intensity of every pixel on the display. The graphics adapter may include a RAMDAC (Random Access Memory Digital-to-Analog Converter) to convert graphics image data stored in the frame buffer from digital to analog form for display on an analog display. Depending on the refresh rate of the display, a display refresh unit frequently reads the contents of the frame buffer.

It is often desirable to display graphics information that is generated by a computer on a remote display. Sometimes it is desirable to provide this type of remote graphics display across a communication network. One approach to providing graphics image data to a remote display involves reading data from the frame buffer back into the memory of the computer system, compressing the data, assembling the data into IP (Internet Protocol) packets, and then sending the packets to the destination computer over the communication network.

It may be seen from the foregoing that there is considerable data movement on the computer which increases latency and computational overhead. This problem is exacerbated when a large display is used to display an image associated with a large workspace. In order to provide such a large display, a composite screen may be constructed by using multiple physical display units. The multiple physical display units comprising the composite screen are controlled in concert so that they present the illusion of one large logical screen to the viewer. This kind of functionality has become known as “single logical screen” functionality. The above-referenced U.S. Pat. No. 6,084,553 discloses a system and method for a computer system to recognize and initialize an arrangement of a plurality of physical display units as a single logical screen (SLS).

### SUMMARY OF THE INVENTION

In accordance with an embodiment of the present invention, a method for transmitting graphics image data over a communication network for display on a single logical screen comprised of a plurality of physical display units is disclosed. The method comprises reading graphics image data from a plurality of frame buffers of a graphics adapter, each of the plurality of frame buffers storing graphics image data corresponding to different ones of the plurality of physical display units, and formatting at least a portion of the graphics image data stored in each of the plurality of frame buffers into a plurality of packets for transmission by a network interface of the graphics adapter over the communication network for display on the single logical screen.

In accordance with another embodiment of the present invention, a graphics adapter is disclosed. The graphics adapter comprises a plurality of frame buffers, each of the plurality of frame buffers operable to store graphics image data to be displayed on different ones of a plurality of physical display units of a single logical screen. The graphics adapter further comprises a network interface operable to receive at least a portion of the graphics image data stored in each of the plurality of frame buffers, the network interface further operable to format the received graphics image data into a plurality of packets for transmission over a communication network for display on the single logical screen.

In accordance with yet another embodiment of the present invention, a method for transmitting graphics image data over a communication network for display on a single logical screen comprised of a plurality of physical display units is disclosed. The method comprises reading graphics image data from a plurality of frame buffers of a graphics adapter, each of the plurality of frame buffers storing graphics image data corresponding to different ones of the plurality of physical display units, formatting at least a portion of graphics image data stored in each of the plurality of frame buffers into a plurality of packets for transmission by a network interface of the graphics adapter over the communication network, and transmitting the plurality of packets over the communication network in response to formatting of the graphics image data into the plurality of packets for display on the single logical screen.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of an exemplary system on which the teachings of the present invention may be practiced;

FIG. 2 is a logical block diagram of a single logical screen coupled to a destination device in accordance with an embodiment of the present invention;

FIG. 3 is a logical block diagram of a graphics device in accordance with an embodiment of the present invention;

FIG. 4 is a flowchart of a method for communicating graphics image data over a communication network for display on a single logical screen in accordance with an embodiment of the present invention;

FIG. 5 is a flowchart of a method for communicating graphics image data over a communication network for display on a single logical screen in accordance with another embodiment of the present invention;

FIG. 6 is a flowchart of a method for communicating graphics image data over a communication network for display on a single logical screen in accordance with yet another embodiment of the present invention; and

FIG. 7 is a flowchart of a method for displaying graphics image data received over a communication network on a single logical screen in accordance with an embodiment of the present invention.

### DETAILED DESCRIPTION OF THE DRAWINGS

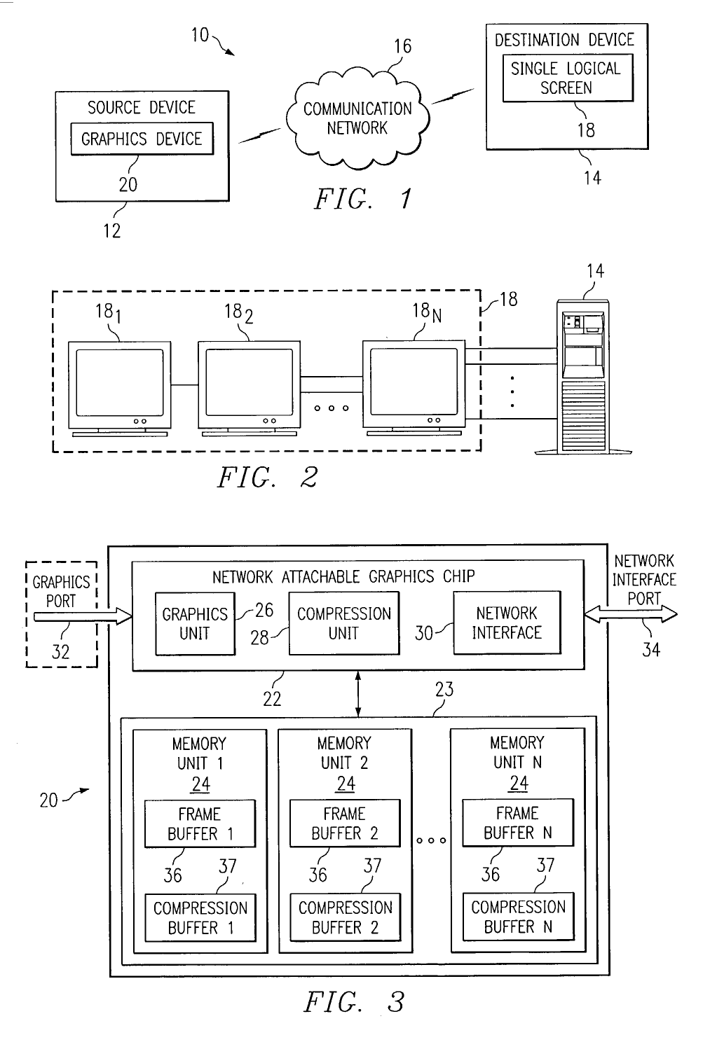

The preferred embodiment of the present invention and its advantages are best understood by referring to FIGS. 1 through 7 of the drawings, like numerals being used for like and corresponding parts of the various drawings.

There is a desire for a system and method for communicating graphics image data over a communication network for display on a single logical screen. In an embodiment of the present invention, this is accomplished by reading graphics image data from a plurality of memory units of a graphics device, each memory unit corresponding to a physical display unit of the single logical screen, compressing the graphics image data, and transmitting the graphics image data over a communication network.

FIG. 1 is a block diagram of an exemplary system 10 on which the teachings of the present invention may be practiced. System 10 preferably comprises at least one source device 12 communicating over a communication network 16 with at least one destination device 14. Communication network 16 may comprise an intranet, an extranet and/or the Internet.

Destination device 14 may be a processor-based system, for example a computer. Destination device 14 may comprise a single logical screen (SLS) 18 comprising a plurality of physical display units, such as those described in the above-referenced U.S. Pat. Nos. 6,084,553, 6,215,486 and 6,249,294. However, the invention is not so limited and destination device 14 may comprise any type of SLS now known or later developed. Furthermore, if desirable, SLS 18 may be separate from destination device 14. In such an embodiment, SLS 18 may be coupled to destination device 14 or coupled directly to communication network 16.

Source device 12 may be a processor-based system, for example, a computer. One or more source devices 12 may communicate with each other over a communication network (not shown), such as a local area network. Source device 12 may comprise a graphics device 20, such as a graphics adapter, for example a graphics adapter as described in the above-referenced U.S. Patent Application entitled, “SYSTEM AND METHOD FOR COMMUNICATING GRAPHICS IMAGE DATA OVER A COMMUNICATION NETWORK”. Although in the illustrated embodiment as shown in FIG. 1, graphics device 20 is part of source device 12, the invention is not so limited. In alternative embodiments, graphics device 20 may not be part of source device 12. In such an embodiment, graphics device 20 may be coupled to source device 12 or directly coupled to communication network 16.

Although, the preferred embodiment of the present invention for communicating graphics image data is described herein with reference to a single graphics device comprising a plurality of memory units, each memory unit corresponding to a physical display unit of the SLS, the invention is not so limited. In alternative embodiments, a plurality of graphics devices may be used, each graphics device corresponding to a physical display unit of the SLS. In such an embodiment, each graphics device preferably comprises a single memory unit, although it may comprise more than one memory unit. If desired, graphics device 20 may comprise a plurality of input ports for receiving instructions from source device 12, each input port for receiving instructions relating to a physical display unit of the SLS.

The preferred embodiment of the present invention for communicating graphics image data is described herein with reference to a graphics adapter. However, the invention is not so limited. In alternative embodiments, graphics device 20 may be a network video apparatus, for example a network video apparatus as described in the above-referenced U.S. Patent Application entitled “SYSTEM AND METHOD FOR COMMUNICATING GRAPHICS OVER A NETWORK”.

FIG. 2 is a logical block diagram of SLS 18 coupled to destination device 14 in accordance with an embodiment of the present invention. SLS 18 may be coupled to destination device 14 by any means now known or later developed. SLS 18 comprises a plurality of physical display units 18₁ through 18_{N}. Each physical display unit may be a Cathode Ray Tube (CRT), a Liquid Crystal Display (LCD), a Thin Film Transistor (TFT), a Light Emitting Diode (LED), organic polymers, and/or the like now known or later developed. Each physical display unit of SLS 18 displays a portion of the entire image to be displayed.

FIG. 3 is a logical block diagram of graphics device 20 in accordance with an embodiment of the present invention. Graphics device 20 of FIG. 3 is preferably a graphics adapter. Graphics adapter 20 comprises a network attachable graphics chip 22 coupled to a memory subsystem 23. Network attachable graphics chip 22 preferably comprises a graphics unit 26, a compression unit 28 and a network interface 30.

Graphics unit 26 is a conventional graphics unit which renders the image to be displayed on SLS 18. Rendering of an image typically comprises translating high-level instructions to bitmap images which comprise a matrix of pixels. The process of rendering is known in the art and as such will not be described in detail herein. The image may be rendered based at least in part on instructions received from source device 12 or instructions received from destination device 14. Instructions from source device 12 are preferably received via a graphics port 32. In an alternative embodiment, instructions may be received via a network interface port 34 coupled to network attachable graphics chip 30. If desired, in such an embodiment, graphics adapter 20 may not include graphics port 32.

Preferably, memory subsystem 23 comprises a plurality of memory units 24. Preferably, the number of memory units 24 is equal to the number of physical display units 18₁ through 18_{N} comprising SLS 18. Preferably, each memory unit 24 corresponds to a single physical display unit. Each memory unit 24 preferably comprises a frame buffer 36. Each frame buffer 36 is used to store information about the portion of the rendered image corresponding to the physical display unit which corresponds to the respective memory unit. Each frame buffer 36 may store information, such as color, transparency values, depth and/or the like, for each pixel in the respective portion of the rendered image corresponding to the memory unit. Thus, the plurality of frame buffers store information for each pixel in the rendered image. Each memory unit 24 may also comprise a compression buffer 37. Compression buffer 37 may be used to store different types of compression data, for example a current image buffer, a previous image buffer, a residual buffer, an error buffer, a motion estimation buffer, and/or the like.

Although, in the illustrated embodiment graphics adapter 20 comprises multiple memory units 24, each with its own frame buffer 36, the invention is not so limited. If desired, a single memory unit may be used. In such an embodiment, the single memory unit may comprise a single frame buffer logically divided into multiple segments, each segment storing graphics image data for a single physical display unit of SLS 18. If desired, the single memory unit may comprise a plurality of frame buffers, each frame buffer storing graphics image data for a single physical display unit of SLS 18. The single memory unit may comprise a single compression buffer logically divided into multiple segments, each segment storing image buffers for a single physical display unit of SLS 18. If desired, the single memory unit may comprise a plurality of compression buffers, each compression buffer storing image buffers for a single physical display unit of SLS 18.

Compression unit 28 of network attachable graphics chip 22 preferably compresses the data stored in the plurality of frame buffers 36. Compression unit 28 preferably includes compression logic optimized for use with graphics image data stored in frame buffer 36. However, the invention is not so limited and any kind of compression logic may be used by compression unit 28. Compression unit 28 may be implemented using general-purpose hardware components, such as a digital signal processor or microprocessor, and appropriate software for controlling the operation of the hardware components. If desired, compression unit 28 may be implemented using dedicated hardware, e.g., an Application Specific Integrated Circuit (ASIC) that is specially designed for carrying out the compression. If desired, compression unit 28 may be a separate chip on graphics device 20. In such an embodiment, compression unit 28 may be implemented using dedicated hardware, an ASIC or a Field Programmable Gate Array (FPGA) that is specially designed for carrying out the compression.

Network interface port 34, for example an Ethernet port, an Infiniband port, a fiber port, a wireless network transceiver, and the like, is preferably coupled to network attachable graphics chip 22. Network interface 30 formats the graphics image data for transmission over a network, such as communication network 16. It converts the graphics image data into packets to be transmitted to destination device 14 via network interface port 34 over communication network 16. The graphics image data may be obtained by network interface 30 either from compression unit 28 or from frame buffers 36. For example, in one embodiment, graphics image data from frame buffers 36 may be compressed by compression unit 28 and provided to network interface 30. In another embodiment, after compressing the graphics image data, compression unit 28 may store the data back into the respective frame buffers and network interface 30 may read the compressed graphics image data directly from the frame buffers. In yet another embodiment, for example when compression of graphics image data is not desired, network interface 30 may read graphics image data directly from frame buffers 36.

If desired, graphics adapter 20 may also comprise at least one video transmitter (not shown), for example an analog transmitter and a digital transmitter, coupled to each memory unit 24. Preferably, the analog and digital transmitters are also coupled to each other. The analog transmitter comprises a conventional RAMDAC (Random Access Memory Digital-to-Analog Converter) and may be used to convert graphics image data stored in memory unit 24 from digital format into an analog format to be transmitted to an analog device, such as an analog monitor which may be coupled to source device 12, via an analog video port (not shown). The digital transmitter comprises a conventional Digital Visual Interface (DVI) transmitter and may be used to transmit graphics image data in digital format from each memory unit 24 to a digital device, such as a digital monitor which may be coupled to source device 12, via a digital video port (not shown). If desired, graphics adapter 20 may not include graphics port 32 for receiving graphics commands. Instead graphics adapter 20 may receive graphics commands over communication network 16 via network interface port 34. The graphics command may be received from source device 12 or from destination device 14.

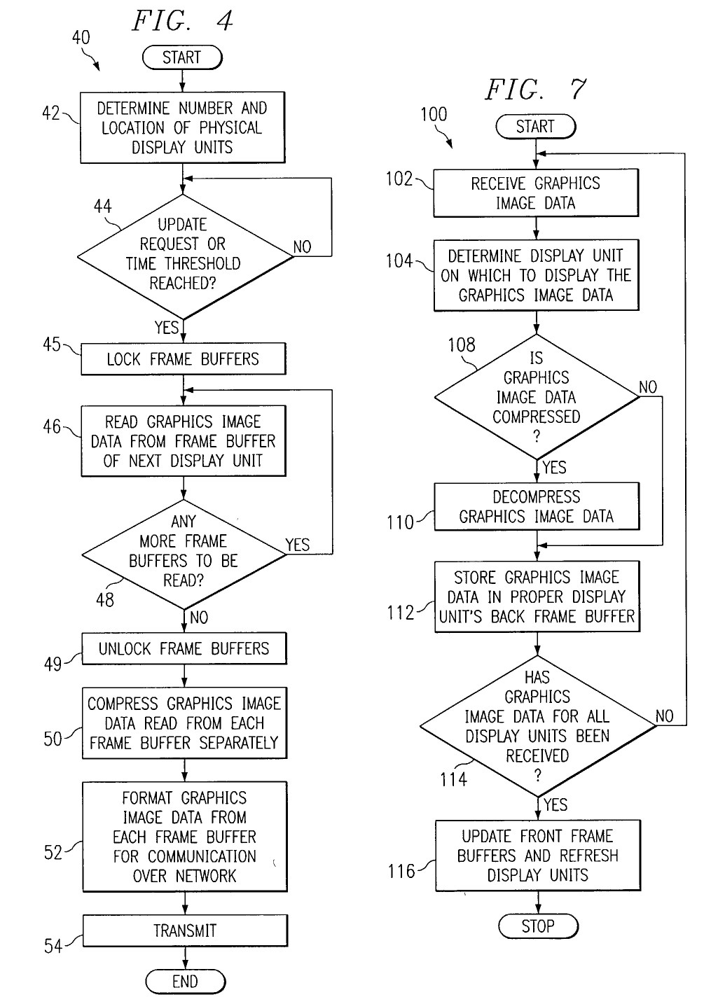

FIG. 4 is a flowchart 40 of a method for communicating graphics image data over a communication network for display on a single logical screen in accordance with an embodiment of the present invention. In step 42, the number of physical display units comprising SLS 18 is determined. The physical layout of the physical display units may also be determined. If desired, the locations and/or the Internet Protocol (IP) addresses of these physical display units may also be determined in this step. In step 44, graphics adapter 20 waits for either the lapse of a predetermined period of time or the receipt of an update request. The predetermined period of time may be dependent upon the refresh rate of display units 18₁ through 18_{N} comprising SLS 18. The update request may be received by graphics adapter 20 from source device 12 via graphics port 32. The request may also be received by graphics adapter 20 from destination device 14 via network interface port 34 over communication network 16.

Upon the occurrence of one of the above events, frame buffers 36 are locked (step 45) as it is desirable that the contents of the frame buffers remain unchanged during the next step. In step 46, graphics image data from frame buffer 36 of the next display unit to be read is read by compression unit 28. The graphics image data may be stored in compression buffer 37 of the respective memory unit 24. If desired, color coalescing may be performed in this step. A Display Refresh Unit (DRU) (not shown) may perform the task of color coalescing. The DRU may be part of network attachable graphics chip 22 or may be coupled to network attachable graphics chip 22. Color coalescing is the process of merging images of multiple display surfaces, such as a primary display surface and one or more overlay planes into a single image. One or more color look-up tables containing colors for the pixels may be stored in registers (not shown) on graphics unit 26. A window identifier may be used to determine the color look-up table to be used. Based on the value for the pixels which may be stored in frame buffer 36, the colors for the pixels are obtained from the determined color look-up table.

In step 48, a determination is made as to whether there are any more frame buffers to be read. If there are additional frame buffers to be read, then the process at step 46 is executed for the frame buffer corresponding to the next display unit of SLS 18. If there are no additional frame buffers to be read, that indicates that frame buffers corresponding to all the display units of SLS 18 have been read. Once all the frame buffers have been read, frame buffers 36 are unlocked (step 49). The content of frame buffer(s) 36 may then be changed, if desired. In step 50, graphics image data read from each frame buffer 36 is separately compressed, preferably by compression unit 28. Compression of graphics image data prior to transmission over communication network 16 significantly reduces the amount of data that is transmitted over communication network 16. Step 50 is optional and, if desired, may be omitted.

In step 52, graphics image data is formatted for communication over communication network 16, preferably by network interface 30. Network interface 30 may read graphics image data from frame buffer 36 or may receive graphics image data directly from compression unit 28. Preferably, graphics image data is formatted into a plurality of packets suitable for transmission over communication network 16 using a communication protocol, such as Internet Protocol (IP). Each physical display unit of SLS 18 may be identified by a display unit identifier. Each formatted data packet includes, among other things, identification information of destination device 14 to which the graphics image data is to be transmitted, identification information of the display unit of SLS 18 on which the graphics image data included in the packet is to be displayed, and/or the like. Identification information of destination device 14 may include for example an IP address of destination device 14. Identification information about destination device 14 and the different display units of SLS 18 may be received by graphics adapter 20 either from source device 12 or from destination device 14.

In step 54, the formatted graphics image data is transmitted over communication network 16 to destination device 14, preferably as one or more IP packets. The packets include a portion of the graphics image data (payload), identification information about destination device 14 and identification information about the display unit of SLS 18 on which to display the graphics image data. If desired, the same graphics image data may be transmitted to more than one destination device 14. This may be accomplished, for example, by creating data packets with the same payload information but different identification information corresponding to the different destination devices. If desired, the graphics image data may be transmitted via graphics port 32 to source device 12. Transmitting the graphics image data to source device 12 allows the source device to perform further processing of the graphics image data as desired. By transmitting packets with the same payload to more than one device, the same data may be presented to users of multiple destination devices, thereby enabling sharing of graphics image data by these multiple users.

It is desirable to read all the frame buffers in a short time period in order to avoid “tearing” of the rendered image. As such in the flowchart of FIG. 4, graphics image data from each frame buffer 36 is read prior to any graphics image data being compressed and formatted for transmission over communication network 16 to destination device 14. The method described herein with reference to the flowchart of FIG. 4 contemplates that graphics image data from the plurality of frame buffers 36 are read in serial. However, the invention is not so limited.

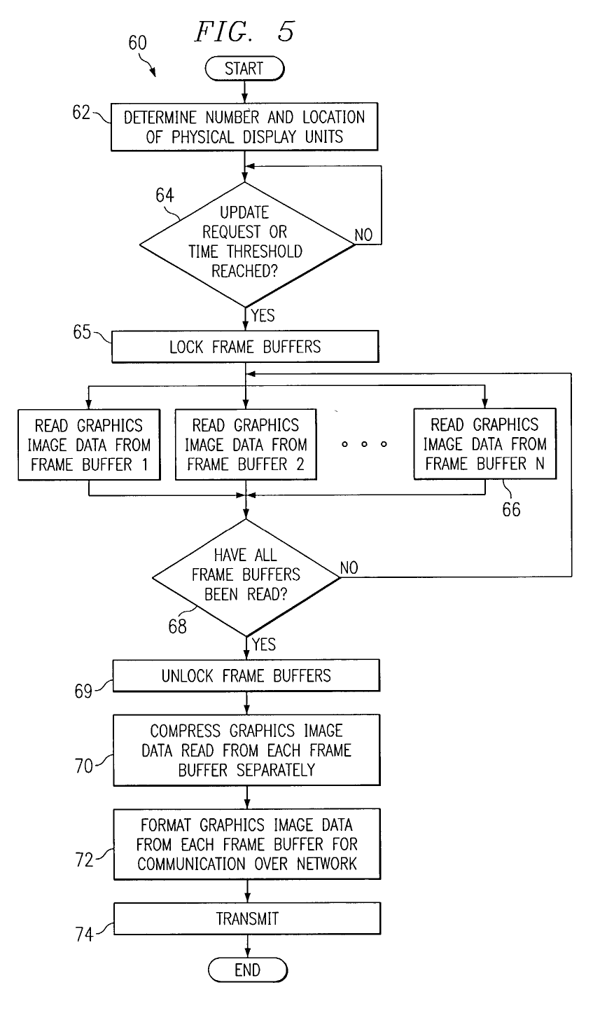

FIG. 5 is a flowchart 60 of a method for communicating graphics image data over a communication network for display on a single logical screen in accordance with another embodiment of the present invention. In step 62, the number of physical display units comprising SLS 18 is determined. The physical layout of the physical display units may also be determined. If desired, the locations and/or the IP addresses of these physical display units may also be determined in this step. In step 64, graphics adapter 20 waits for either the lapse of a predetermined period of time or the receipt of an update request. The predetermined period of time may be dependent upon the refresh rate of display units 18₁ through 18_{N} comprising SLS 18. The update request may be received by graphics adapter 20 from source device 12 via graphics port 32. The request may also be received by graphics adapter 20 from destination device 14 via network interface port 34 over communication network 16.

Upon the occurrence of one of the above events, frame buffers 36 are locked (step 65). In step 66, graphics image data from each of the frame buffers 36 storing graphics image data to be displayed on SLS 18 is read by compression unit 28 in parallel. The graphics image data may be stored in compression buffer(s) 37 of the respective memory unit(s) 24. If desired, color coalescing may be performed in this step.

In step 68, a determination is made as to whether frame buffers for all the display units have been read. Once graphics image data from the frame buffers corresponding to all the display units of SLS 18 have been read, frame buffers 36 are unlocked (step 69). In step 70 graphics image data read from each frame buffer 36 is separately compressed, preferably by compression unit 28. Step 70 is optional and, if desired, may be omitted.

In step 72, graphics image data is formatted for communication over communication network 16, preferably by network interface 30. Network interface 30 may read graphics image data from frame buffer 36 or may receive graphics image data directly from compression unit 28. Preferably, graphics image data is formatted into a plurality of packets suitable for transmission over communication network 16 using a communication protocol, such as IP. Each formatted data packet includes, among other things, identification information of destination device 14 to which the graphics image data is to be transmitted, identification information of the display unit of SLS 18 on which the graphics image data included in the packet is to be displayed, and/or the like. Identification information of destination device 14 may include for example an IP address of destination device 14. Identification information about destination device 14 and the different display units of SLS 18 may be received by graphics adapter 20 either from source device 12 or from destination device 14.

In step 74, the formatted graphics image data is transmitted over communication network 16 to destination device 14, preferably as one or more IP packets. The packets include a portion of the graphics image data (payload), identification information about destination device 14 and identification information about the display unit of SLS 18 on which to display the graphics image data. If desired, the same graphics image data may be transmitted to more than one destination device 14. If desired, the formatted graphics image data may be transmitted via graphics port 32 to source device 12.

It is desirable to read all the frame buffers in a short time period in order to avoid “tearing” of the rendered image. As such in the flowchart of FIG. 5, graphics image data from all the frame buffers 36 is read in parallel. Once the graphics image data from all the frame buffers 36 has been read, it is compressed, formatted and transmitted.

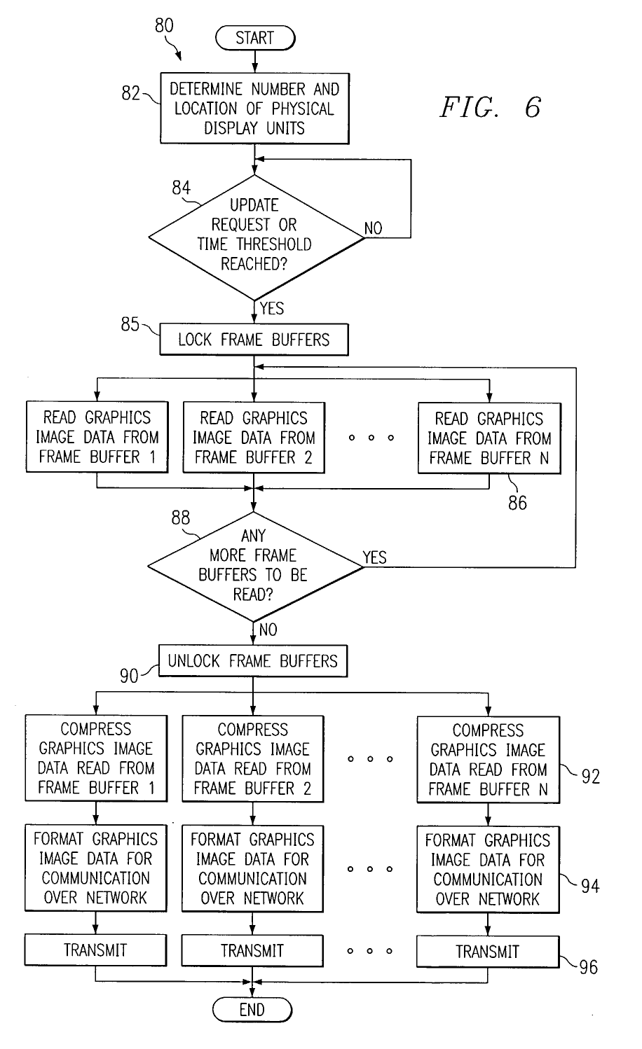

FIG. 6 is a flowchart 80 of a method for communicating graphics image data over a communication network for display on a single logical screen in accordance with yet another embodiment of the present invention. In step 82, the number of physical display units comprising SLS 18 is determined. The physical layout of the physical display units may also be determined. If desired, the locations and/or the IP addresses of these physical display units may also be determined in this step. In step 84, graphics adapter 20 waits for either the lapse of a predetermined period of time or the receipt of an update request. The predetermined period of time may be dependent upon the refresh rate of display units 18₁ through 18_{N} comprising SLS 18. The update request may be received by graphics adapter 20 from source device 12 via graphics port 32. The request may also be received by graphics adapter 20 from destination device 14 via network interface port 34 over communication network 16.

Upon the occurrence of one of the above-events, frame buffers 36 are locked (step 85). In step 86, graphics image data stored in each of the frame buffers 36 and to be displayed on SLS 18 is read by compression unit 28 in parallel. The graphics image data may be stored in compression buffer(s) 37 of the respective memory unit(s) 24. If desired, color coalescing may be performed in this step. In step 88, a determination is made as to whether frame buffers for all the display units have been read. Once graphics image data from the frame buffers corresponding to all the display units have been read, frame buffers 36 are unlocked (step 90).

In step 92, graphics image data read from the respective frame buffers is separately compressed in parallel, preferably by compression unit 28. Step 92 is optional and, if desired, may be omitted.

In step 94, graphics image data of each frame buffer is formatted in parallel for communication over communication network 16, preferably by network interface 30. Network interface 30 may read graphics image data from frame buffer 36 or may receive graphics image data directly from compression unit 28. Preferably, graphics image data is formatted into a plurality of packets suitable for transmission over communication network 16 using a communication protocol, such as IP. Each formatted data packet includes, among other things, identification information of destination device 14 to which the graphics image data is to be transmitted, identification information of the display unit of SLS 18 on which the graphics image data included in the packet is to be displayed, and/or the like. Identification information of destination device 14 may include for example an IP address of destination device 14. Identification information about destination device 14 and the different display units of SLS 18 may be received by graphics adapter 20 either from source device 12 or from destination-device 14 itself.

In step 96, the formatted graphics image data is transmitted over communication network 16 to destination device 14, preferably as one or more IP packets. The packets include a portion of the graphics image data (payload), identification information about destination device 14 and identification information about the display unit of SLS 18 on which to display the graphics image data. If desired, the same graphics image data may be transmitted to more than one destination device 14. If desired, the formatted graphics image data may be transmitted via graphics port 32 to source device 12. Transmission of formatted graphics image data may proceed as soon as the data for a particular frame buffer has been formatted. This reduces latency and increases throughput. However, in an alternative embodiment, if desired, transmission of formatted graphics image data may proceed once the graphics image data from all the frame buffers 36 has been read, compressed and formatted.

A technical advantage of an exemplary embodiment of the present invention is that graphics image data may be transmitted over a communication network to a remote destination device for display on a SLS which comprises multiple physical display units. Moreover, the graphics image data may be addressed and sent to more than one destination device. Thus, multiple destination devices may be simultaneously supported by the same graphics adapter. The multiple destination devices may be provided with the same image data thereby allowing multiple users to collaborate.

FIG. 7 is a flowchart 100 of a method for displaying graphics image data received over a communication network on a single logical screen in accordance with an embodiment of the present invention. Preferably, the graphics image data is received by a destination device, such as destination device 14 (FIG. 1), to be displayed on SLS 18 (FIG. 2). As discussed above, SLS 18 comprises a plurality of physical display units 18₁ through 18_{N}. Each physical display unit comprises a front frame buffer (not shown) and a back frame buffer (not shown) to store graphics image data. The graphics image data stored in the front frame buffer is used to store graphics image data currently being displayed on the physical display unit. The back frame buffer stores graphics image data to be displayed during a future refresh of the physical display unit.

In step 102, graphics image data is received from a source device, such as a computer, a server, a graphics device, an Internet appliance and/or the like, for example source device 12 (FIG. 1) or graphics device 20 (FIG. 3), over a communication network, such as communication network 16, via a network interface port. The data is received preferably as a plurality of packets.

In step 104, the physical display unit on which the received graphics image data is to be displayed is determined. Identification information, included in the received data packets, identifying the display unit on which the graphics image data is to be displayed may be used for this determination.

In step 108, a determination is made as to whether the graphics image data is in compressed form. If the graphics image data is in compressed form, then in step 110 the graphics image data is decompressed. In step 112, the decompressed data is stored in a frame buffer, preferably a back frame buffer, of the physical display unit on which the graphics image data is to be displayed and execution proceeds to step 114.

If, in step 108, it is determined that the graphics image data is not in compressed form, then execution proceeds directly to step 112. In step 112, the graphics image data is stored in the back frame buffer and execution proceeds to step 114. In step 114, a determination is made as to whether graphics image data for all the display units 18₁ through 18_{N} of SLS 18 have been received. It is desirable to update the physical display units of SLS 18 simultaneously in order to avoid “tearing” of the displayed image. As such, if the graphics image data for all the display units have not been received, then the process at step 102 is executed.

If, in step 114, it is determined that graphics image data for all the display units of SLS 18 has been received, then in step 116, the front frame buffers of the display units are updated and the display units are refreshed. Thus, graphics image data received over a communication network may be displayed on the multiple physical display units of SLS 18.

In order to update the front frame buffers, preferably the front frame buffer of each display unit is swapped with the back frame buffer of the same display unit. Preferably, the swapping is performed by changing a front frame buffer pointer to point to the back frame buffer. A back frame buffer pointer may be changed to point to the front frame buffer. However, if desired, in alternative embodiments, in order to swap the front frame buffer with the corresponding back frame buffer, the data from the back frame buffer may be copied into the front frame buffer.

A technical advantage of an exemplary embodiment of the present invention is that graphics image data may be received over a communication network from a remote source device for display on a SLS which comprises multiple physical display units.

If desired, the different steps discussed herein may be performed in any order and/or concurrently with each other. Furthermore, if desired, one or more of the above described steps may be optional or may be combined without departing from the scope of the present invention

What is claimed is:

1. A method for transmitting graphics image data over a communication network for display on a single logical screen comprised of a plurality of physical display units, said method comprising:
reading graphics image data from a plurality of frame buffers of a graphics adapter, each of said plurality of frame buffers storing graphics image data corresponding to different ones of said plurality of physical display units; and
formatting at least a portion of said graphics image data stored in each of said plurality of frame buffers into a plurality of packets for transmission by a network interface of said graphics adapter over said communication network for display on said single logical screen.

2. The method of claim 1, further comprising transmitting said plurality of packets over said communication network.

3. The method of claim 1, further comprising locking said plurality of frame buffers prior to said reading.

4. The method of claim 1, further comprising unlocking said plurality of frame buffers prior to said formatting.

5. The method of claim 1, further comprising unlocking said plurality of frame buffers subsequent to said reading.

6. The method of claim 1, further comprising receiving an update request from a destination device with which said single logical screen is associated prior to said reading.

7. The method of claim 6, wherein said reading graphics image data comprises reading graphics image data from said plurality of frame buffers in response to receiving said update request.

8. The method of claim 6, further comprising adding identification information identifying said destination device to each of said plurality of packets.

9. The method of claim 8, wherein said identification information is an Internet Protocol (IP) address of said destination device.

10. The method of claim 1, further comprising adding identification information identifying at least one of said plurality of physical display units to each of said plurality of packets.

11. The method of claim 1, further comprising:
adding identification information identifying a physical display unit of said plurality of physical display units to each of a first plurality of packets of said plurality of packets; and
adding identification information identifying another physical display unit of said plurality of physical display units to each of a second plurality of packets of said plurality of packets.

12. The method of claim 11, wherein each of said first plurality of packets comprises graphics image data to be displayed on said physical display unit and each of said second plurality of packets comprises graphics image data to be displayed on said another physical display unit.

13. The method of claim 1, further comprising adding identification information to each of said plurality of packets, said identification information identifying respective ones of said plurality of physical display units on which to display said graphics image data of respective ones of said plurality of packets.

14. The method of claim 1, further comprising compressing said graphics image data stored in each of said plurality of frame buffers prior to said formatting.

15. The method of claim 1, further comprising:
receiving, by a destination device, said plurality of packets over said communication network;
determining respective ones of said plurality of physical display units on which to display said graphics image data of respective ones of said plurality of packets; and
refreshing respective ones of said plurality of physical display units with said graphics image data of said respective packets.

16. The method of claim 15, further comprising:
storing, prior to said refreshing, said received graphics image data in respective ones of a plurality of frame buffers, each of said plurality of frame buffers being associated with a physical display unit of said plurality of physical display units.

17. A graphics adapter, comprising:
a plurality of frame buffers, each of said plurality of frame buffers operable to store graphics image data to be displayed on different ones of a plurality of physical display units of a single logical screen; and
a network interface operable to receive at least a portion of said graphics image data stored in each of said plurality of frame buffers, said network interface further operable to format said received graphics image data into a plurality of packets for transmission over a communication network for display on said single logical screen.

18. The graphics adapter of claim 17, further comprising a network interface port coupled to said network interface, said plurality of packets being transmitted from said network interface to said communication network via said network interface port.

19. The graphics adapter of claim 18, wherein said network interface port is selected from the group consisting of an Ethernet port, an Infiniband port, and a wireless network transceiver.

20. The graphics adapter of claim 17, further comprising a compression unit coupled to said plurality of frame buffers and operable to compress graphics image data of said plurality of frame buffers into compressed graphics image data.

21. The graphics adapter of claim 20, said network interface further operable to format said compressed graphics image data into a plurality of packets for transmission over said communication network.

22. The graphics adapter of claim 17, said plurality of packets being transmitted to at least one destination device.

23. A method for transmitting graphics image data over a communication network for display on a single logical screen comprised of a plurality of physical display units, said method comprising:
reading graphics image data from a plurality of frame buffers of a graphics adapter, each of said plurality of frame buffers storing graphics image data corresponding to different ones of said plurality of physical display units;
formatting at least a portion of graphics image data stored in each of said plurality of frame buffers into a plurality of packets for transmission by a network interface of said graphics adapter over said communication network; and
transmitting said plurality of packets over said communication network in response to formatting of said graphics image data into said plurality of packets for display on said single logical screen.

24. The method of claim 23, further comprising compressing said graphics image data stored in each of said plurality of frame buffers prior to said formatting.

25. The method of claim 23, wherein said reading comprises reading in parallel said graphics image data from said plurality of frame buffers.

26. The method of claim 23, wherein said formatting comprises formatting in parallel said at least a portion of graphics image data stored in each of said plurality of frame buffers into said plurality of packets.

27. The method of claim 24, wherein said compressing comprises compressing in parallel said graphics image data stored in each of said plurality of frame buffers.

28. The method of claim 23, further comprising adding to each of said plurality of packets identification information identifying a destination device with which said single logical screen is associated.

29. The method of claim 23, further comprising adding to each of said plurality of packets identification information identifying respective ones of said plurality of physical display units on which to display said graphics image data of said respective packets.

30. The method of claim 23, further comprising locking said plurality of frame buffers prior to said reading step.

31. The method of claim 30, further comprising unlocking said plurality of frame buffers after said reading step.
